(19) United States
(12) Patent Application Publication
(10) Pub. No.: US 2021/0224545 A1
(43) Pub. Date: Jul. 22, 2021

(54) SYSTEM AND METHOD FOR ASSOCIATING A VIDEO RECORDING TO AN EVENT

(71) Applicant: Nishant Shah, Aurora, IL (US)

(72) Inventor: Nishant Shah, Aurora, IL (US)

(21) Appl. No.: 16/895,010

(22) Filed: Jun. 8, 2020

Related U.S. Application Data
(63) Continuation-in-part of application No. 16/748,869, filed on Jan. 22, 2020.

(51) Int. Cl. G06K 9/00; H04N 5/225; H04N 5/232

(52) U.S. Cl. CPC G06K 9/00718; H04N 5/2254; G06K 2009/00738; H04N 5/232939; H04N 5/23206

(57) ABSTRACT

A video recording system is disclosed and claimed. In particular, the disclosed video recording system maintains a master stream of video and audio when recording is initiated, but also allows the user to create additional label streams by activating an input control. The label stream can be terminated by activating input control a second time. The label stream comprises only the portion of the video and audio between the activations of the input control, while the master stream will contain all audio and video that is recorded on the device. The video stream can be associated with an event, and labeled with an event name by activation of an event control. The event-labeled video stream is stored and organized in a remote data storage unit by activation of a remote storage control. The event-labeled video streams and the label streams are accessible by multiple video recording systems through a network.

### CROSS-REFERENCE

This application is a continuation-in-part application of U.S. application Ser. No. 16/748,869, filed Jan. 22, 2020 and entitled MULTI-STREAM VIDEO RECORDING SYSTEM USING LABELS, which is incorporated herein for all purposes in their entirety.

### FIELD OF THE DISCLOSURE

The present disclosure relates to video recording systems, and more particularly, to a video recording system and method for associating and labeling a video stream with an event, and storing the event-labeled video stream in a remote data storage unit for easy access through a network.

### BACKGROUND

Video cameras have become ubiquitous. In particular, every smartphone produced can now record video in at least HD resolution, and many are capable of recording video at 4K resolution or even higher. Video cameras are now frequently used to record important events. For example, parents often will record their children's events, such as athletic contests, concerts, school plays, and other events. People often record other personal events, including weddings, graduations, and vacations, to name a few. Entertainment events, such as sporting events, theater performances, and other events, are also often recorded. Also, video cameras are often now used for public safety purposes. Security cameras are used by both governmental and private entities to secure certain locations, and traffic cameras are now commonly used for both speed and red-light policing. In addition, cameras are sometimes used in operating rooms so that a precise record of surgery can be maintained. Recording the surgery allows any mistakes to be ascertained after the surgery, which simplifies any resulting litigation. Similarly, recording a surgery allows a surgeon to prove that she executed a surgery within the standard of care.

The use of video recordings allows the details of the recordings to be kept forever, as long as sufficient digital storage is available. Given that a terabyte of cloud storage is now available at a nominal cost, it can be assumed that sufficient digital storage is available to store any video that is taken.

However, network bandwidth is still comparatively expensive in terms of both money and time. In particular, typical high-speed Internet download speeds range between 10 Mbps to 100 Mbps. Given that 4K video recorded at 30 frames per second requires approximately 375 MB of data, a typical high-speed Internet user might spend nearly an hour to download a 10-minute video, and the time to download a two-hour performance would be truly prohibitive. In most cases, however, the person downloading the video is only interested in a small portion of a video. For example, in the case of a school talent competition, a parent downloading the video is likely only interested in their child's performance; accordingly, the parent is likely interested in five minutes of a two-hour performance.

Presently, the only way that a parent could download a video of only their child's performance would be for the videographer or an editor to “slice” the master recording of the talent show into several smaller videos using post-processing software. For example, an editor could produce individual videos of each child's performance and label them appropriately in the school's video folder. This process would require the editor to use video editing software to identify natural breaks in the talent show performances (such as when each performer left the stage), and cut the master video file at those breaks using the video editing software. This process is time-consuming and requires the use of a second piece of highly technical software.

Accordingly, a need exists for the simplified creation of videos from a master video based on a specific event. Such an event could include different performances at a talent show, different acts in a play, a period within an athletic competition, changes of a traffic signal for traffic camera, or different phases of operation for an operating room camera.

### OBJECTS OF THE DISCLOSURE

It is an object of the disclosure to provide a video recording system that allows an operator to easily mark one or more slices of a master video recording as comprising separate video streams in real-time.

It is another object of the disclosure to provide a video recording system that allows a videographer to mark one or more slices of a master video recording as comprising separate video streams in real-time.

It is another object of the disclosure to provide a video recording system that allows a remote monitor to mark one or more slices of a master video recording as comprising separate video streams in real-time.

It is another object of the disclosure to provide a smartphone that allows a videographer to mark one or more slices of a master video recording as comprising separate video streams in real-time.

R is another object of the disclosure to provide a video recorder that allows a videographer to mark one or more slices of a master video recording as comprising separate video streams in real-time.

It is another object of the disclosure to provide an add-on device for use with a video recorder that allows a videographer to mark one or more slices of a master video recording as comprising separate video streams in real-time.

It is another object of the disclosure to provide a smartphone that allows a remote monitor to mark one or more slices of a master video recording as comprising separate video streams in real-time.

It is another object of the disclosure to provide a networked video recorder that allows a remote monitor to mark one or more slices of a master video recording as comprising separate video streams in real-time.

It is another object of the disclosure to provide a networked add-on device for use with a video recorder that allows a remote monitor to mark one or more slices of a master video recording as comprising separate video streams in real-time.

It is another object of the disclosure to provide a simple-to-use user interface allowing a user to mark one or more slices of a master video recording as comprising separate video streams in real-time.

It is yet another advantage of the disclosure to provide a video recording system that associates and labels a video stream with an event.

Another objective is to securely store the event-labeled video stream in a remote data storage unit for easy access through a network.

It is yet another advantage of the disclosure to organize video streams by event names associated with different events.

Another possible advantage is to associate a master video stream, or slices of the master video stream to an event.

Yet another advantage is to store the event names of the video streams in a remote data storage unit.

It is yet another advantage of the disclosure to segregate the events in individual folders in the remote data storage unit.

Another possible advantage is to provide a network that allows for easy access to the event-labeled video streams.

Yet another advantage is to provide allow for remote access to the event-labeled video streams.

It is yet another advantage of the disclosure to enable automatic creation of an event based on user-creation, calendar, social media, etc.

Another possible advantage is to provide events that have sub-events.

Yet another advantage is to provide querying tools to search video streams across events, timestamps, and locations.

Yet another advantage is to automatically produce a folder in the remote data storage unit for an event, simultaneous with video production.

Yet another advantage is to allow a professional to record an event and make different clips (event names) available for download through a network.

Other advantages of this disclosure will be clear to a person of ordinary skill in the art. It should be understood, however, that a system, an apparatus or a method could practice the disclosure while not achieving all of the enumerated advantages, and that the claims define the protected disclosure.

### SUMMARY OF THE DISCLOSURE

The present disclosure provides a system and method for creating multiple related video streams out of a single master video stream. Aspects of the present disclosure address one or more of the objectives mentioned above by describing a system and method for creating multiple related video streams out of a single master video stream. The following presents a much-simplified summary of the disclosure in order to provide a basic understanding of some aspects of the systems and methods for creating multiple video streams out of a single master video stream. This summary is not intended to identify key or critical elements or aspects of the disclosure, nor is it intended to set forth or delineate the scope of the claims of this application for patent. The following summary merely presents some of the concepts of the disclosure in a simplified form as a prelude to the more detailed description provided below.

A video recording system is described and claimed herein. In particular, the video recording system comprises a body, including a lens. A sensor, such as a CMOS sensor or a CCD sensor is disposed within the body and optically coupled to the lens; i.e., light gathered by the lens is directed to the sensor. The sensor produces a stream of digital video data that is analyzed and framed by a video processor that is coupled to the sensor. The video processor writes digital video frame data to a storage device, such as FLASH memory.

The video recording system also includes a processor that is coupled to the storage device and maintains a logical master stream of digital video. The logical master stream includes a start pointer and an end pointer. The start pointer is set to the first location of storage where the video for the particular stream was recorded, and the end pointer is set to the location of storage holding the most recently written frame of digital video data. Also, the video recording system includes an input control coupled to the processor that, on activation, creates a second logical stream of video. The second logical stream of the video includes a start pointer that is set to the most recent value of the end pointer of the logical master stream of video data.

In an additional embodiment of the disclosed video recording system, the second logical stream of video further comprises a second end pointer, and, when the input control is activated a second time, the second end pointer is set to the value of the end pointer of the logical master stream at the time that the input control is activated the second time.

Also, when the input control is activated a second time, a name can be assigned to the second stream of video. The name can either be automatically generated, using, for example, a date and time index, or the name can be entered manually by a user.

Additional logical streams of video can be created by activating the input control.

The input control can be, for example, a hard button, a touch display on a smartphone, a voice control, or another type of control. In addition, in certain embodiments, the video recording system can be network controlled. In such an embodiment, the video recording system will include a network port and will stream video data to a remote site. It will also receive network commands, including activation of the input control to create and manage additional streams from the remote site.

The disclosed video recording system can be implemented as, for example, a smartphone, a digital camcorder, or a digital camera.

In some embodiments, a second embodiment of the video recording system and method is configured to associate and label a video stream with an event. The event-labeled video stream, or multiple spliced sections of the master video stream may then be stored in a remote data storage unit for easy access through a network. Multiple video recording systems and network members can share and access the video streams directly from the remote data storage unit.

In another embodiment, the video recording system is operable to record an event. The event can be a calendar event, a user-generated event, a social media event, or a holiday event, which are all recordable as video or images. The recorded event generates a master video stream. The master video stream, or spliced sections thereof, are labeled with an event name. By associating the video streams with the event, the video streams can be organized and accessed based on events.

The event-organization feature is in addition to labeling the video streams with a name, time stamp, or location, as described above. This allows for event-based organization, name-based organization, time-based organization, and location-based organization of video streams. In this manner, the video recording system allows for selective querying of the video streams across events, labels, time stamps, and locations.

The video recording system includes an event control that serves to label the event with an event name prior to recording. The event control can be, for example, a hard button, a touch display on a smartphone, a voice control, or another type of control. When the event control is activated, a keyboard appears to allow a user-defined event name to be entered in an event name text box. Once the event name is selected, the done/save button can be pressed to save the event name.

After naming the event, a record control feature of the video recording system is activated to video record the event. The video recording generates a master video stream of the event. In this manner, the master video stream is both associated with the event, and is labeled with the event name.

The record control initiates video recording of the event. As described above, the recording can be a physical master stream stored on the video recorder, or a logical master stream that activates a start pointer and an end pointer to delimit the master video stream into multiple labeled video streams. In both cases, the video stream is associated with the event name, and organized based on the event.

The event-labeled video streams can also be labeled with a name, location, or time stamp through use of a stream control feature on the video recording system. When the stream control is first activated, a keyboard appears to allow a stream name to be entered in a label name control, such as, a text box. Once the name is selected, the done/save button can be pressed to save the name for the newly created labeled video stream. The stream control can be activated a second time to mark the end limit of a spliced labeled video stream.

The event-labeled video stream may be stored and segregated by event name in a remote data storage unit that is in communication with a storage device in the video recording system. When the record control is active, the video stream associated with the event automatically transmits to the remote data storage unit for storage. Or, the video stream associated with the event can be manually transmitted to the remote data storage unit through activation of a remote storage control feature. The remote storage control can be, for example, a hard button, a touch display on a smartphone, a voice control, or another type of control.

The video streams associated with the event are accessible by multiple video recording systems, including a ClippyCam, through a network. The video recording systems communicate with the remote data storage unit, and with each other, through the network. Network members can indicate that —a video stream and event are associated, and provide the event name. Any member of the network can share and access the event-labeled video stream based on the event name. A network administrator can regulate access to the video streams in the data storage unit. This regulation can include recording the event, and selectively making the event-labeled video streams accessible to network members.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is a perspective view of a stage surrounded by rows of seating being recorded by a video recording system.

FIGS. 2a through 2f are screenshot views of an exemplary touchscreen user interface for a video recording system constructed per this disclosure.

FIG. 3 is a simplified block diagram of a video recording system constructed per this disclosure.

FIG. 4 is a structure diagram illustrating the different types of streams discussed herein and the relationship between those different types of streams.

FIG. 5 is a simplified flow chart illustrating the software operation of a video recording system constructed per this disclosure.

FIG. 6a is a perspective view of a digital camcorder implementing the label stream feature disclosure herein.

FIG. 6b is a perspective view of a digital camera implementing the label stream feature disclosed herein.

FIG. 7 is a perspective view of a video recorder system utilizing a wireless control device live streaming video to a wireless control device.

FIG. 8 is a simplified flow chart illustrating the operation of a wireless control device, implementing the label stream functionality disclosed herein.

FIG. 9 is a screen shot view of an event of a school play being recorded by a video recording system.

FIG. 10 is a screen shot view of the event of a school play being recorded by a video recording system, showing the event control activated to label the event, and the remote storage control activated to transmit the event to a remote data storage unit.

FIG. 11 is a screen shot view of an event of a school play being recorded by a video recording system, showing the keyboard used for entering an event name.

FIG. 12 is a block diagram showing the relationship between an event and multiple subevents.

FIG. 13 is a block diagram of a network for multiple video recording systems to access an event-labeled video steam from a remote data storage unit.

FIG. 14 is a simplified flow chart illustrating an exemplary method for associating a video recording to an event per this disclosure.

FIG. 15 is a screenshot of ClippyCam enabled mobile communication device displaying multiple events.

FIG. 16 is a screenshot of ClippyCam enabled mobile communication device providing an event text box to label the events.

FIG. 17 is a screenshot of ClippyCam enabled mobile communication device with the event of a College Gathering, the location of the event, and the date and time of the event, which are into the event text box.

FIG. 18 is a screenshot of ClippyCam enabled mobile communication device displaying the subevents of the College Gathering event.

FIG. 19 is a screenshot of ClippyCam enabled mobile communication device with a fully entered subevent.

FIG. 20 is a screenshot of ClippyCam enabled mobile communication device displaying video recordings of the College Gathering event, showing the entire video, and clips of the video.

FIG. 21 is a screenshot of ClippyCam enabled mobile communication device displaying scenes of the recording for the College Gathering event.

FIG. 22 is a screenshot of ClippyCam enabled mobile communication device displaying snapshot images of the scenes of the recording for the College Gathering event.

FIG. 23 is a screenshot of ClippyCam enabled mobile communication device displaying a Record button for recording the event, and also displaying a Cut Clip button that functions to delete an old clip, and start a new clip of the recording.

FIG. 24 is a screenshot of ClippyCam enabled mobile communication device displaying a recording, and offering the option to Stop Clip, but not stopping the master recording.

FIG. 25 is a screenshot of ClippyCam enabled mobile communication device displaying a pop-up box requesting of the recording is for a prior saved event.

A person of ordinary skills in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skills in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed system and method, reference is made to the accompanying drawings, which form a part hereof, and in which are shown by way of illustration various example devices, systems, and environments in which aspects of the disclosed system and method can be practiced. Other specific arrangements of parts, example devices, systems, and environments, can be used, and structural modifications and functional modifications can be made without departing from the scope of the disclosed system and method.

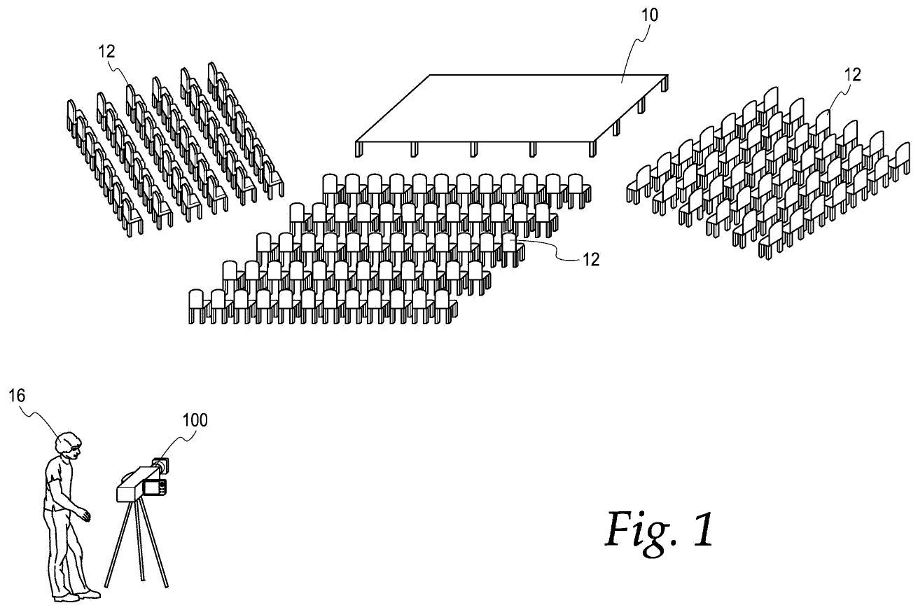

Turning to the Figures and FIG. 1 in particular, a video camera 100 films a performance on stage 10 surrounded by numerous chairs 12. As explained herein, the video camera 100 can be a digital camcorder, a digital camera, or even a smartphone. In particular, an operator 16 aims the video camera at performers (not shown) on the stage and records their performance. A person of ordinary skill in the art would understand that while the disclosed system and method are depicted as recording a performance on a stage, the functional and structural features of the disclosed system and method can be translated to other environments with little or no modification. For example, the disclosed system and method can easily be translated for use in security cameras, traffic cameras, and operating room cameras.

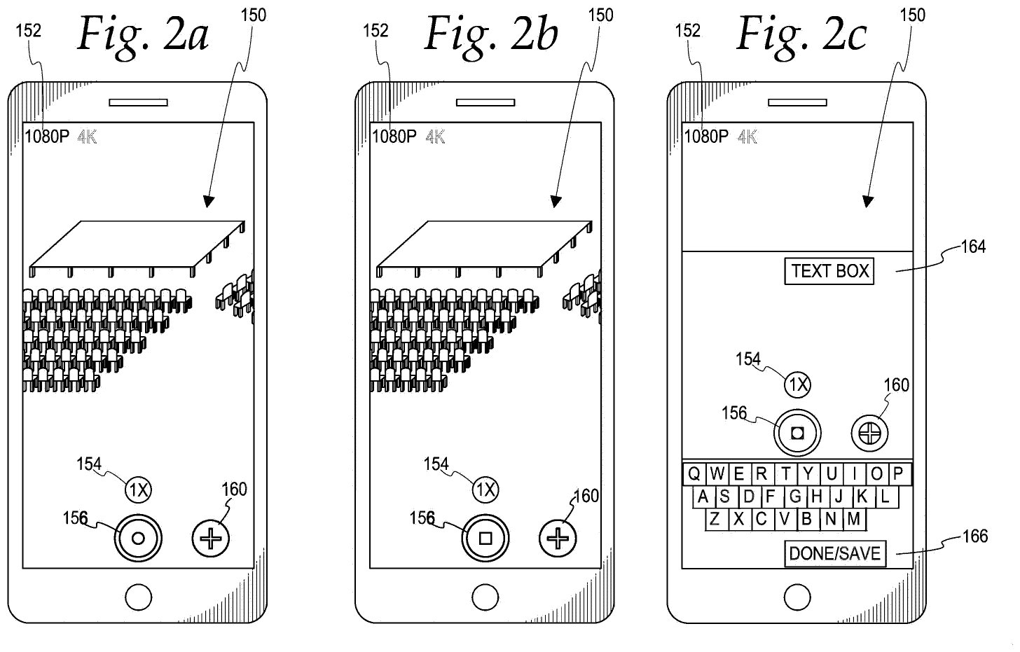

Turning to FIGS. 2a through 2f, an exemplary interface for the camera operator is disclosed. The exemplary interface operates on a video device that includes, for example, a lens and sensor. In particular, the exemplary interface is shown as being implemented on a smartphone, tablet, or other handheld assistants. However, it should be understood that the principles of the interface can easily be used on other types of devices as well, such as digital camcorders, digital cameras, or remote-control software operating on a computer or other device. The exemplary interface includes a video area 150, which depicts a real-time view of a scene captured from the lens. The exemplary interface also includes a resolution indicator 152. In particular, as depicted, video resolution is presently set at 1080P, but an option for 4K video is also present. By pressing the 4K portion of the resolution indicator 152 a user can change the recorded video resolution from 1080P to 4K. Other resolutions can also be used, and no particular resolution is a limitation of this disclosure. The exemplary interface also includes a zoom control 154. As depicted, the zoom control 154 allows a user to cycle through several zoom options, such as 1×, 2×, and 4×. Alternatively, the zoom control 154 can be pressed to the left to zoom out and to the right to zoom in, with near analog granularity. Other zoom interfaces are also possibly, and the specific configuration and use of the zoom control 154 is not a limitation of this disclosure. By adjusting the zoom control 154, the scene depicted in the video area 150 will either zoom in or out accordingly, depending on how the zoom is being adjusted.

The exemplary interface also includes a record control 156. The record control 156 allows the user to initiate the recording of video, or cause the recording of video to pause or stop. The record control 156 is shown as inactive (not recording) in FIG. 2a and active (recording) in FIG. 2b. In particular, as depicted, the record control has 156 a circle in the middle of the control when inactive, and a square in the middle of the control when active (recording). It should be understood that many other representations of the record control 156 and its active and inactive state can be utilized and still fall within the scope of the disclosed system and method.

The exemplary interface also includes a new control, which is referred to herein as a stream control 160. Typically, when the record control 156 is not active, the stream control 160 will be displayed as inactive, i.e., as it is depicted in FIGS. 2a and 2b. However, when the record control 156 is active, the stream control 160 can be activated, and when first activated, as it is in FIG. 2c, a keyboard, such as a smartphone system keyboard, can appear to allow a stream name to be entered in a label name control, such as, for example, a text box 164. Once the name is selected, the done/save button 166 can be pressed to save the name for the newly created label stream. For the sake of clarity, the illustrated interface displays the stream control 160 as a circle containing a plus sign when inactive, and a circle containing a smaller circle immediately surrounding a plus sign when active. When the stream control 160 is pressed, and as explained further herein, the video recording system 100 will create an additional label stream. In particular, the video recording system 100 will continue to record the main video stream, which is hereafter referred to as the master video stream. In addition, the video recording system 100 will also create a new label stream starting at the time index that the stream control 160 is activated and continuing until the stream control 160 is pressed again. The new label stream created by the stream control 160 is a subset of the master stream; i.e., it contains the same video and audio content as the master stream except that it is limited to the video encompassed by a starting time index and an ending time index.

When the stream control 160 is pressed a second time, the new label stream is assigned an end time index, and the new label stream is closed. Also, the appearance of the stream control 160 can be toggled when the stream control 160 is pressed. For example, when the stream control 160 is pressed the first time, the stream control 160 can be highlighted with an additional interior circle around the depicted plus sign or using some other type of highlight to indicate that a label stream is presently being created. When the stream control 160 is pressed a second time, the highlight of the stream control 160 can be removed so that the camera operator knows that only the master stream is presently being recorded.

This latter sequence is depicted in FIGS. 2d through 2f. In FIG. 2d, the master stream is active, as indicated by the record control 156 being active. In addition; in FIG. 2d, a label stream is also active, as depicted by the label control 160 being active. In FIG. 2e, the label stream has been deactivated, as seen by the label control 160 being inactive, and in FIG. 2f, the master stream has been deactivated, as depicted by the record control 156 being inactive.

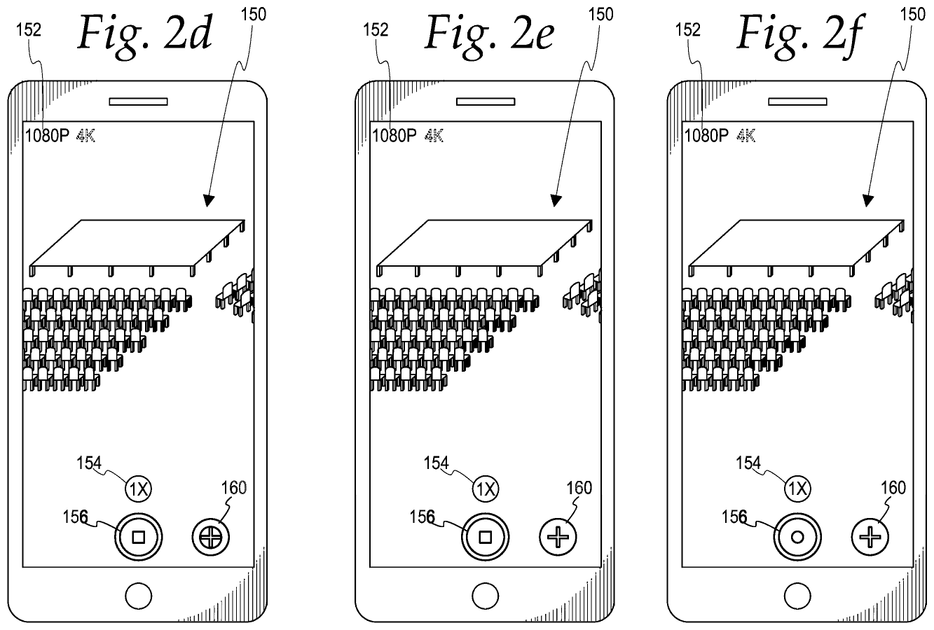

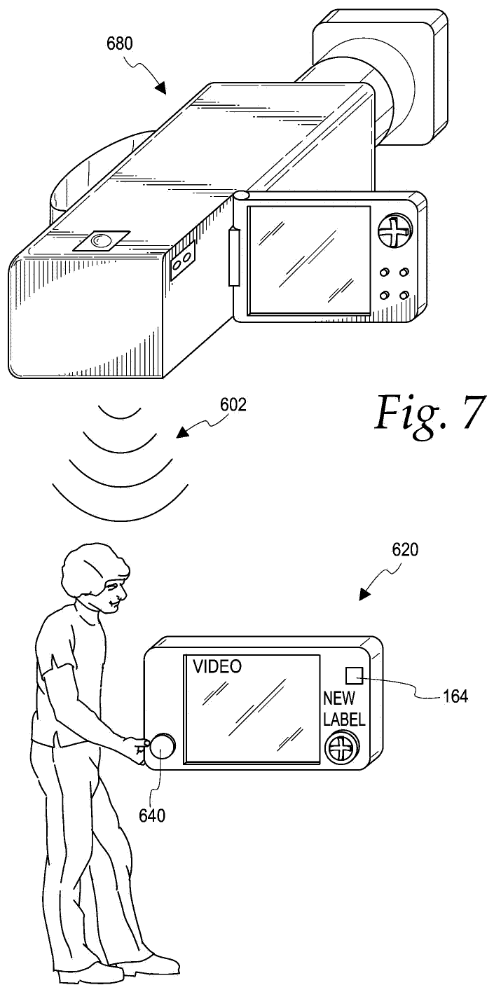

Turning to FIG. 3, a simplified block diagram of a video recording system 100 is depicted. In particular, the primary components of a video recording system 100 are depicted, whether the actual video recording system 100 is a smartphone, a digital camera, or a digital camcorder. Typically, the components of the video recording system 100 will reside in a body (not shown in this figure), although it is possible in certain implementations that different components can reside in separate enclosures, such as in the embodiment depicted in FIG. 7. The video recording system 100 will generally include a lens 202. The lens can be, for example, a small curved glass lens with a focal length of about 18 mm to 55 mm, although it should be noted that the characteristics of the lens, and even the inclusion of the lens, is not a limitation of this disclosure. The lens focuses incoming light onto a sensor 204. The sensor 204 can be, for example, a CCD sensor, a CMOS sensor, or another equivalent sensor. In addition, the size of the sensor 204 can vary from full-frame or larger down to arbitrarily small sensors. Typically, the output of a video sensor 204 will be processed by a video processor 206, which will process the video from the sensor and write or commit full frames of video to storage 208. The video processor 206 may process data from the sensor 204 at a frame rate such as, for example, 60 Hz, although other frame rates, such as 15 Hz, 24 Hz, 30 Hz, 90 Hz, 120 Hz, 240 Hz, 480 Hz, 960 Hz, 1920 Hz, or other, arbitrary frame rates can also be used. The video processor 206 may write frame data directly to storage 208 via a DMA channel. However, the processor 210 can also read data from the video processor (or directly from the sensor 204) and write the frame data to storage 208. Accordingly, in certain embodiments of the disclosed video recording system 100, the video processor 206 is entirely extraneous and is not a limitation of this disclosure.

The storage 208 used by the video recording system 100 will typically be FLASH memory, although the primary limitation is that the write speed of the storage 208 is sufficient for the frame rate that the video recording system 100 is operated. The amount of storage can vary, but 1 GB of storage can hold a bit less than 20 minutes of 1080P video at 60 FPS (frames per second). The FLASH memory modules may, for example, be UFS 3.0 FLASH memory or a similar type of FLASH memory that offers sufficient read/write performance.

The microprocessor 210 reads frame data from storage and displays it in real-time on the display 212. The microprocessor 210 also performs housekeeping activities, such as configuring the video processor 206, interfacing with external devices (not shown), accepting input controls 216, and interfacing with an external network 214. The microprocessor 210 can be any suitably fast microprocessor or microcontroller that has appropriate interface capabilities, ranging from an 8-bit device, such as a Microchip® PIC® variant, or similar device, to a 64 bit ARM or x86 device, such as, for example, an ARM Cortex A76 variant.

The input controls 216 allows the camera operator to control the operation of the video recording system 100. The input controls 216 can include, for example, a touch screen system, or a collection of buttons, sliders, joysticks, gesture controls, voice controls, and other input controls, as are typical in video recording systems. The stream control 160 is one of the input controls 216.

The display 212 can be, for example, a Liquid Crystal Display (LCD), an LED or an OLED display, or another type of display as long as the display is of sufficient resolution and refresh rate for the video camera operator to obtain a reasonable view of the scene that is being recorded. In certain implementations, the display 212 can be a touch-sensitive display, so that touch-sensitive input controls can be implemented as needed.

The network interface 214 will typically be wireless using a variant of 802.11, although other wireless networking technology, or even a wired network, can be employed. For example, a 4G or 5G cellular network could also be used, as their transfer speeds are fast enough to accommodate the video streaming and transfer required of the network interface 214. The network interface 214 can be employed for a variety of purposes, including remote control by a remote operator. In such a scenario, the processor 210 may run software, including a video server that will stream the recorded video to a remote site, as well as software to accept various network commands from the remote site. When utilized, the remote device 250 can oversee the operation of the video recording system 100. For example, the remote device 250 can send a command to create a new label stream or terminate a label stream that is presently recording. In certain implementations, the video may not be streamed to the remote site so that lower bandwidth implementations, like BlueTooth®, Zigbee®, or Z-Wave®, could be used. A remote device without streamed video would allow for the implementation of a remote device 250 that could serve solely as a label control 160 and allow the camera operator to hold the remote device 250 in one hand to manage label streams while viewing an event in a location distant from the video camera.

It should be noted that certain embodiments may not include all of the components illustrated in FIG. 3 and described above. For example, a “screen capture” implementation of the disclosed video recording system 100 would not require a lens 202, a sensor 204, or a video processor 206. In addition, such an embodiment may not require a network interface 214 or a remote device 250. Other embodiments may similarly not require certain components. For example, the network interface 214 can interface directly with the video processor 206 and even the sensor 204, so that video can be directly streamed to a remove device 250 via the network interface 214. In addition, certain other components, such as a microphone, may be present in the video recording system 100, but have been omitted for brevity and clarity.

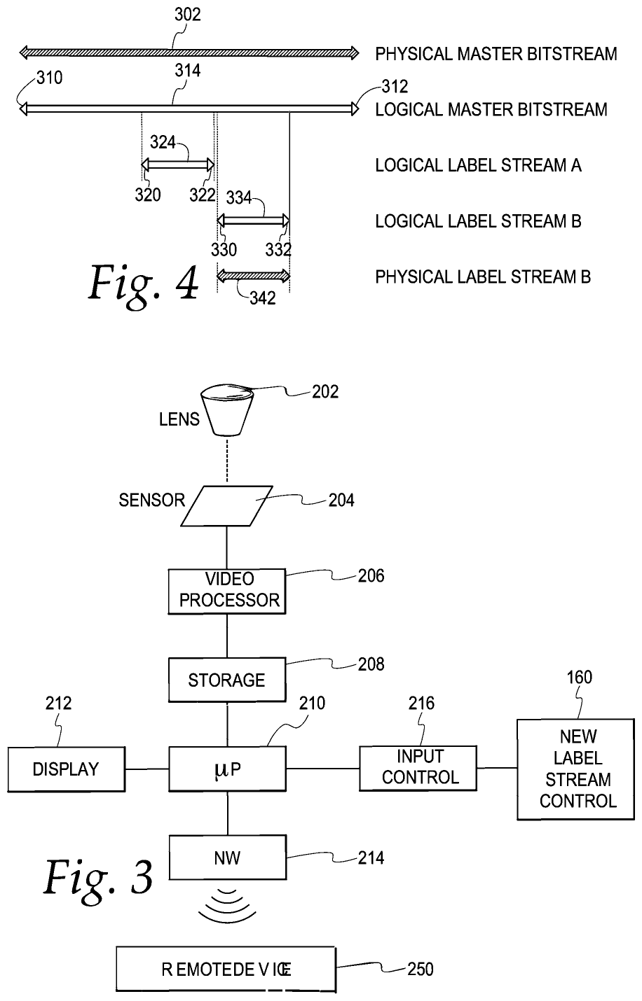

FIG. 4 visually depicts different stream types. While the terms “video stream” or “stream” are used herein, it should be understood that a stream can include both video and audio. At the top is shown the physical master stream 302. The physical master stream 302 is shown as filled in to show that this stream occupies physical memory locations in the storage 208; i.e., it has been written to a physical medium. Generally, a given video recording system 100 will only have one active physical master stream 302 at a time. The physical master stream 302 is instantiated when, for example, the user activates the record control 156, as depicted in FIGS. 2a-2b. Beneath the physical master stream 302 is a logical master stream 314, which is shown as an outline to indicate that it is strictly a logical construction; i.e., it exists as a pair of pointers to physical memory locations. In particular, a logical stream consists of a start pointer 310—in the case of the logical master stream, the start pointer will point to the start of the physical master stream. The logical stream also includes an end pointer 312—in the case of the logical master stream, the end pointer will point to the memory locations in storage 208 holding the most recent frame of video that has been recorded. The end pointer 312 of the logical master stream will be updated after every frame. It should be noted that the creation of a logical master bitstream 310 is a matter of programming convenience, and the disclosed video recording system 100 can be implemented without creating a logical master bitstream 310.

When a label stream is created, it is created as a logical stream, and its start pointer is assigned to the present end pointer 312 of the logical master stream 314. This operation corresponds to, for example, a user activating a label control 160, as depicted in FIG. 2c. As the video is recorded and stored in the physical master bitstream 302 and tracked by the logical master bitstream 312, the end pointer of the label stream is continuously updated to match the end pointer of the logical master stream; i.e., it will point at the latest frame of video that has been recorded. When the label stream is ended, it's end pointer is fixed to the value of the end pointer 312 at the time that the label stream is ended. The fixing of the end pointer of the label stream can correspond to a second press of the label stream control 160, as depicted in FIGS. 2d and 2e. For example, logical label stream A 324 has its start pointer 320 pointing to a first-time index of the logical master stream 314, and its end pointer 322 pointing to a second-time index of the logical master stream 314 that is later than the first-time index. Logical label stream B 334 was created a short time after the end of logical label stream A; accordingly, the start pointer 330 of logical label stream B has a later time index than the end pointer 322 of logical label stream A. Similarly, the end pointer 332 of logical label stream B 334 has a somewhat later time index than the start pointer 330 of logical label stream b 334. While label streams can be utilized in a strictly logical format, in certain cases, it may be desirable to write the label streams to actual physical storage. In such a case, a physical stream can be created. For example, in the case of logical label stream B 334, a corresponding physical stream 342 is also shown. Similarly, the creation of logical label streams can be done away with entirely, and physical streams can be created instead, which will result in duplication of memory storage used for the label streams.

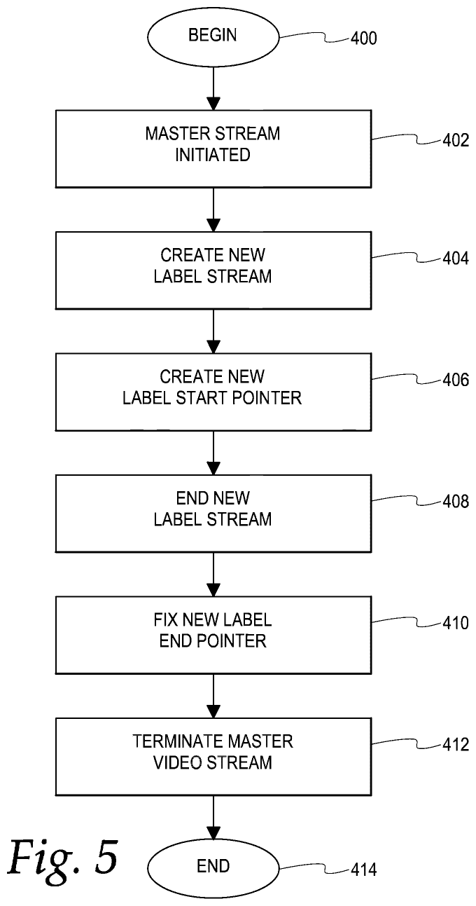

Turning to FIG. 5, a simplified flowchart depicting the operation of a video recording system 100 constructed in accordance with this disclosure is shown. In particular, in step 400, the video recording system 100 is initiated; i.e., it is turned on; startup tasks are performed, etc. In step 402, the record control 156 is activated, and a master stream initiated. As explained above, this would create both a physical master stream and a logical master stream. This step corresponds to, for example, the activation of the record control 156, as depicted in FIGS. 2a and 2b. In step 404, a new label stream is created, and in step 406, the new label stream start pointer is created. As explained above, the new label stream's start point is set to the present end pointer of the logical label stream. This operation corresponds to, for example, the activation of the label control 160, as depicted in FIGS. 2b and 2c. In step 408, the label stream is ended, and its end pointer is fixed to the most recent value of the logical master stream in step 410. This operation corresponds to, for example, a second activation of the label control 160, as depicted in, for example, FIGS. 2d and 2e. In step 412, the master stream is terminated, which is usually accomplished by the user pressing the record control 156 again to cease recording, as depicted in, for example, FIGS. 2e and 2f. In step 414, the video recording system 100 is turned off, ending the operation of the system.

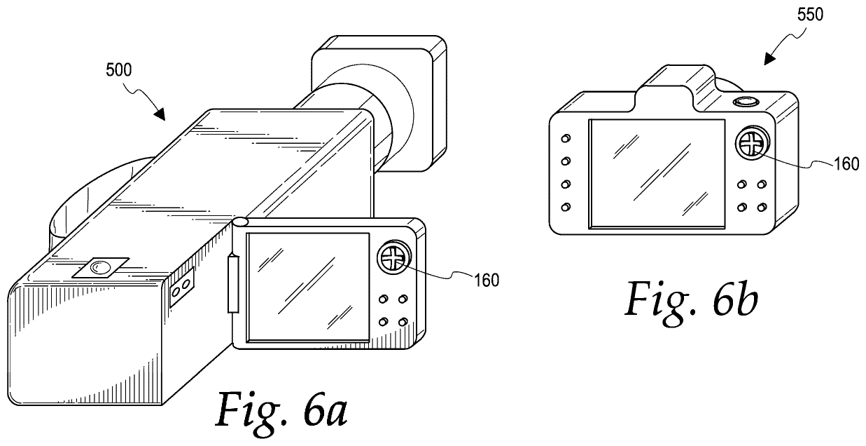

While the user interfaces for the creation of label streams have been shown in the context of a smartphone implementation, FIGS. 6a and 6b illustrate how a digital camcorder 500 and the digital camera 550 could utilize the disclosed label stream feature respectively. In particular, the addition of a stream control 160 to the standard controls already present in a digital camcorder 500 or a digital camera 550, along with the disclosed software changes, would allow implantation of disclosed label stream feature.

Also, one additional embodiment of the label stream system is envisioned. In particular, a software implementation for use with existing digital cameras and digital camcorders could also be constructed, so long as the existing device supported live streaming. Such an implementation would have the advantage of being able to continue to use an expensive, well-functioning camera, while still enjoying the benefits disclosed herein.

Turning to FIG. 7, an embodiment of such a label stream system is pictured. In particular, a digital recording device 680 has an integrated live streaming function with which it broadcasts video data over a wireless network 602, such as an 802.11 network. A wireless control device 620 receives the live stream from the digital recording device 680 over the wireless network 602. The wireless control device 620 will include certain components similar to the video camera 100 of FIG. 3, including a display, which can again be a touch-sensitive display, a processor, storage, and input controls, such as UI widgets that are displayed on the touch-sensitive display, or other buttons, sliders, joysticks, and voice controls. In addition, the wireless control device will contain a wireless network port. Software operating on the wireless network 602 implements the label stream functionality disclosed herein. In particular, the software implements a stream control 160, as well as a label name control 164 that could function similarly to the embodiment previously disclosed herein.

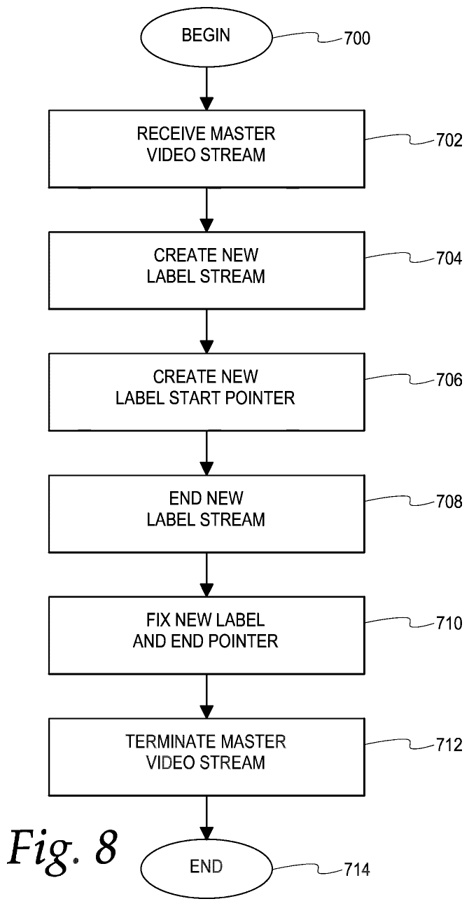

Turning to FIG. 8, a simplified flowchart depicting the operation of a video recording system 100 utilizing the live streaming embodiment of FIG. 7. In particular, in step 700, the video recording system 100 is initiated; i.e., it is turned on, the wireless network 602 is initiated, etc. In step 702, the live stream is initiated by the digital camcorder 500 and received by the wireless control device 620. In accordance with the previous embodiment, this would create both a physical master stream that is recorded into persistent storage on the wireless control device 620 and a logical master stream. In step 704, a new label stream is created, and in step 706, the new label stream start pointer is created. As explained above, the new label stream's start pointer is set to the present end pointer of the logical label stream. In step 708, the label stream is ended, and its end pointer is fixed to the most recent value of the logical master stream in step 710. In step 712, the live stream is terminated, which can be accomplished by the digital camcorder ceasing its live stream or a user pressing the terminate function 640 on the wireless control device. In step 714, the video recording system 100 is turned off, ending the operation of the system.

The structure of the disclosed video recording system 100 has been set forth herein. With regard to its application, this system can have several advantageous uses. The first application would be for the recording of a live performance that will consist of numerous subparts, such as, for example, a school talent show. At such a performance, the video camera operator could create a separate label stream for each performance, and name the streams appropriately; i.e., a first label stream could be named John Smith (assuming that John Smith was the student performing), while a second label stream could be named Ann Jones. Then, the individual label streams could be exported to a website, and parents could then download only the video applicable for their child.

The disclosed video recording system 100 could also be integrated into a security camera system deployed at, for example, a workplace. The disclosed video recording system 100 could be adapted to create separate label streams for each event, such as a particular location within the workplace (like the kitchen or shop floor) over a particular time frame, such as 10 AM to 10:30 AM.

The disclosed video recording system 100 could also be integrated into a traffic camera system deployed at a stoplight. Separate label streams could be created every time that a traffic light changed states, such as from green to red or vice versa. Such a system would allow the system operators to easily identify applicable video when, for example, a person that received a violation notice due to the traffic camera system chose to challenge that violation.

Similarly, the disclosed video recording system 100 could be integrated into an operating room black box system. As an operation proceeded, the video camera operator could create different label streams for each phase of the operation; i.e., preparation, initial incision and cut down, tumor resection, closure, and clean up (assuming the procedure involved the removal of a tumor). Such a system would allow a subsequent viewer to easily access only the part of the operation that was of concern.

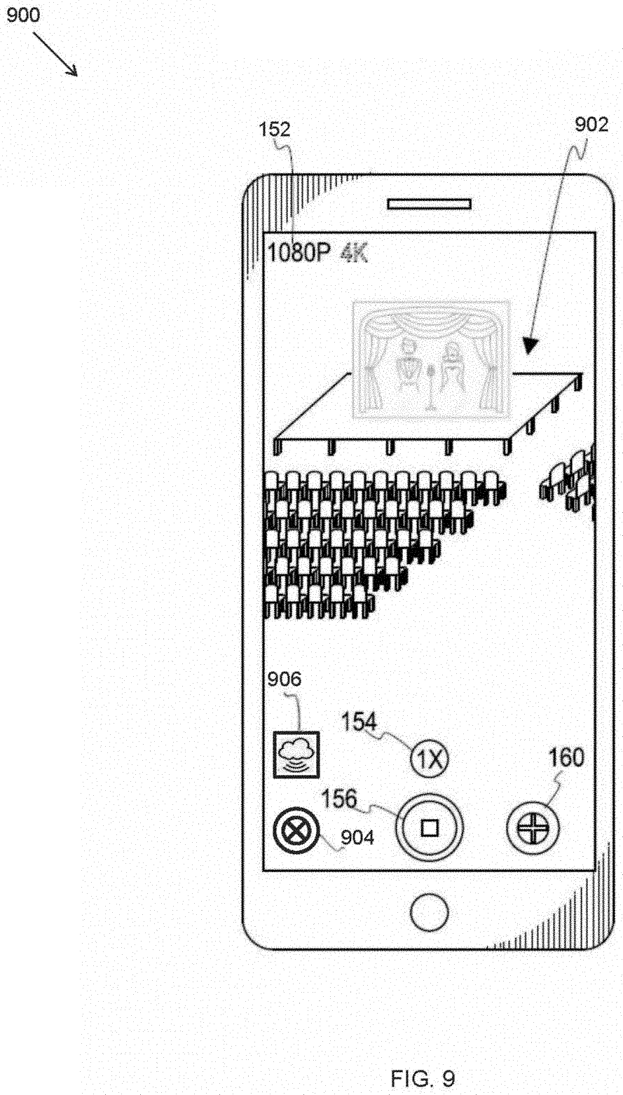

Turning now to FIG. 9, another embodiment of a video recording system 900 is unique in that the recorded video streams are associated with an event 902, which is labeled with a corresponding event name 1104. This association of the video streams with an event 902 is a unique labeling feature that helps organize media streams for easy identification and access. In some embodiments, the event 902 can be a calendar event, a user-generated event, a social media event, or a holiday event. As FIG. 1 referenced, the event 902 is a school play that is being recorded with the video recording system. However, in other embodiments of the present disclosure, any organized activity, special event, or large gathering can be considered an event 902.

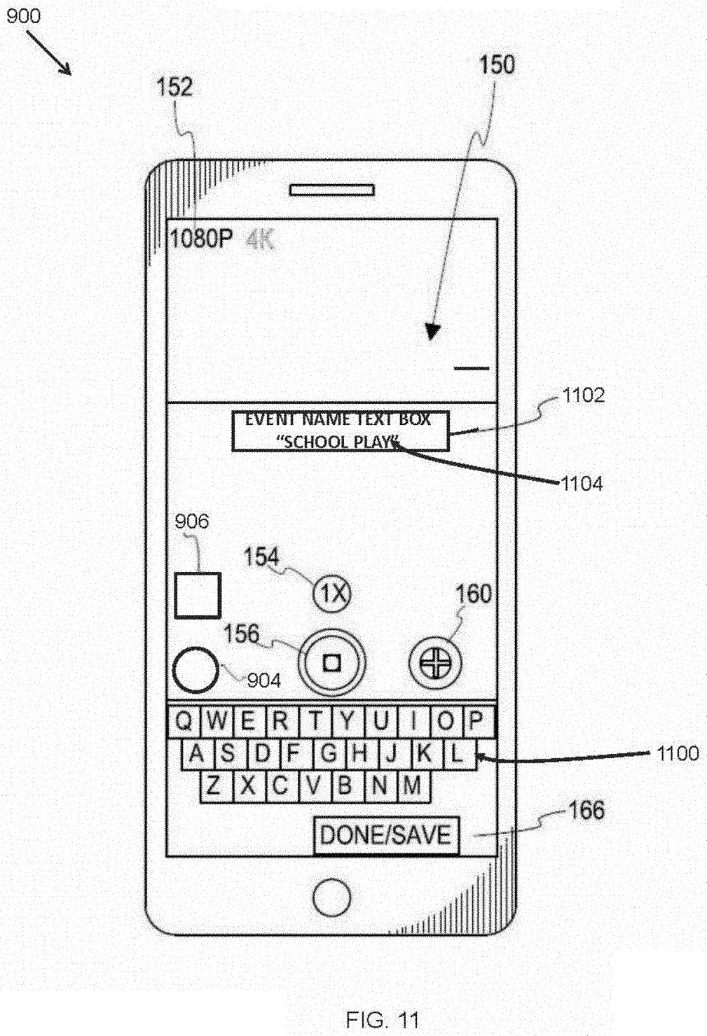

As FIG. 11 shows, the video recording system 900 is configured with a unique event control 904 for labeling the event 902 with an event name 1104, before recording the video or images that associate with the event 902. In one non-limiting embodiment, the video recording system 900 labels the event 902 with a user-defined event name.

For example, a school play is given an event name of “Daughter's School Play—Fall 2020”. In another example, a warehouse inventory job is filmed and labeled as “Warehouse #10—Inventory Jan. 7, 2020”. In yet another example, a security camera in front of a gas station records the interior of the gas station 24/7. The event can be rush hour, which is defined as a busy time of the day. The event is labeled, “Security—Friday 11 am-2 pm”.

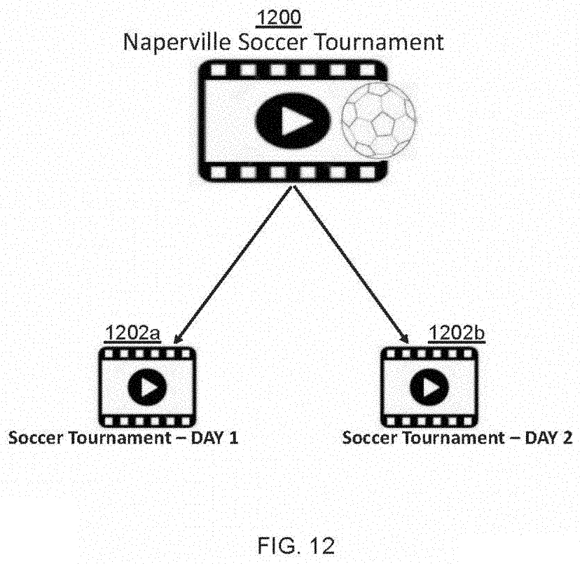

In alternative embodiments of the video recording system 900, an event 1200 comprises one or more subevents 1202a, 1202b. The subevents 1202a-b are simply spliced sections of the video stream for the event 1200. Thus, the recorded event 1200 can be organized into smaller sections of video streams. FIG. 12 references a block diagram, showing the relationship between a soccer tournament event 1200 and two corresponding subevents 1202a-b.

In this example, the event 1200 is a Naperville Soccer Tournament, which occurs over a span of two days. Two subevents 1202a, 1202b of the soccer tournament event 1200 are broken down into the individual days: “Day 1—Playoffs—A vs B” (Sub Event 1); and “Day 2—Playoffs—C vs D” (Sub Event 2). By breaking down the soccer tournament event 1200, into video streams of separate days, the operator can access the desired playoff game, or more specific time lines and locations that make up the event 1200 can be selectively viewed. In yet another embodiment, the subevents 1202a-b can be broken down into sub-subevents, and so on. For example, “Day 1 Playoffs—A vs B” is spliced into a “First Half of the Game” and a “Second Half of the Game”. Furthermore, the events 1200 and subevents 1202a-b can be stored in folders 1306a-c and subfolders for organizing the video streams in a desired configuration.

Further, the video recording system 900 can film an event 902 that encompasses the entirety of a master video stream, or a spliced section of the master video stream. It is significant to note that this event-organization feature is in addition to the labeling feature, described above, in which spliced streams of the master video stream are labeled with a name, time stamp, or location. Thus, by associating the video streams with events, along with other names and labels, the video recording system 900 allows for selective querying of the video streams across various types of events, labels, time stamps, locations, and other categories known in the art of video.

The event labeling is also useful for organizing video streams to be more easily identified and accessed. By associating the master video stream with an event 902, the video streams can be organized for selection based on the type of event 902. Thus, used in conjunction with the name labeling described above, the video streams are adapted for event-based organization, name-based organization, time-based organization, and location-based organization.

As referenced in FIG. 11, the video recording system 900 includes an event control 904 for labeling the event 902 with a user-defined event name 1104. In some embodiments, the event control 904 may include, without limitation, a hard button, a touch display on a smartphone, a voice control operated by voiced recognition software, or another type of control that is operable on the body of the video recording system. The event control 904 is adjacent to the record control 156 and stream control 160, described above.

The event control 904 is activated by the operator to enable labeling of the event 902 with an event name 1104 to as user-defined specification. The event 902 is generally labeled prior to commencement of recording. This pre-recording labeling feature helps the operator in managing the labeling and organization of events while recording the video.

Typically, when the event control 904 is not activated, labeling is not possible, i.e., as it is depicted in FIG. 9. However, when the event control 904 is activated, a keyboard 1100, such as a smartphone system keyboard, appears to allow an event name 1104 to be entered in an event name control box 1102. The event name control box 1102 may include a graphical depiction of a text box into which alphanumeric digits are entered.

As shown in FIG. 11, the keyboard 1100 is configured to allow the event name 1104 to be entered in the event name control box 1102. This can be performed by typing, speaking, or other data entry means. For example, the operator can simply type or voice the desired event name 1104 into the keyboard 1100. Once the event name 1104 is selected, the done/save button 166 can be pressed to save the event name 1104 for the newly created event-labeled video stream.

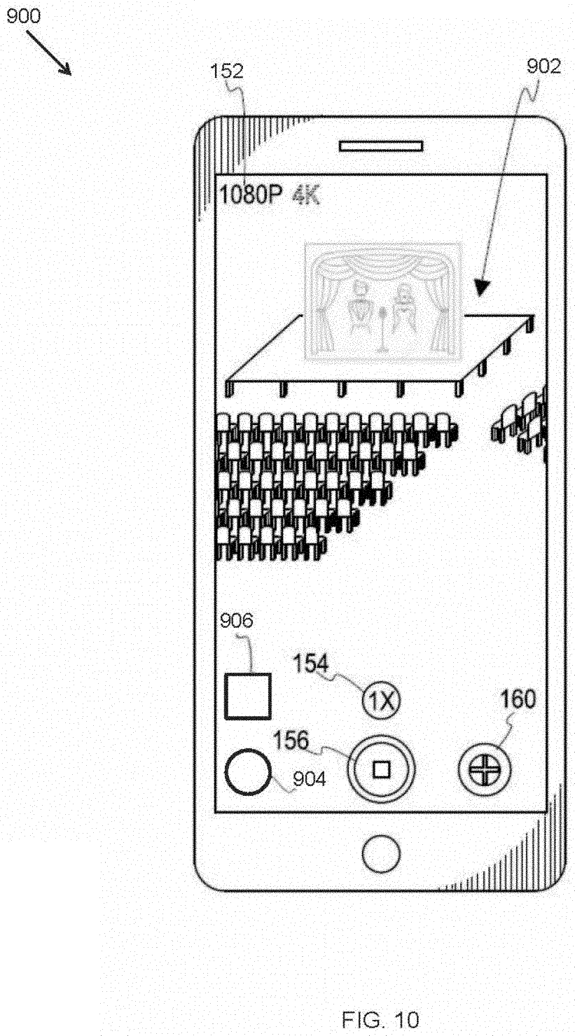

For the sake of clarity, the illustrated interface in FIGS. 9 and 10 display the event control 904 as a circle containing a criss-cross sign when inactive, and an empty circle when active. After naming the event 902, the record control in the video recording system 900 is activated to video record the event 902.

As described above, when recording the event 902, the record control and stream control enable either a full feature master video stream to be produced, or a spliced labeled video stream. When the record control 156 is activated, a master stream is initiated. As explained above, this would create both a physical master stream and a logical master stream. This step corresponds to, for example, the activation of the record control 156, as depicted in FIGS. 2a and 2b.

Also as described above, the video streams can be labeled with a name, location, or time stamp through use of the stream control 160. This labeling function can be in conjunction with the event name 1104 given to the video stream. Thus, when the record control 156 is active, the stream control 160 can be activated to create a name, time stamp, or location label for the video stream.

It is significant to note that the video streams can be labeled, solely with an event name 1104. Whereby, the video stream is not labeled with a name, a time stamp, or a location. Conversely, the video streams may be labeled with a name, a time stamp, and a location label; yet have no event name 1104 associated therewith.

It is also significant to note that while the label video streams are spliced sections of the master video stream; the event 902 can be associated with an entire master video stream, or a spliced section of the master video stream, i.e., labeled video stream.

The video recording system 900 is also unique in that the event-labeled video stream 1304 is securely storable for organized identification and access by the operator, or members of a network 1300. In one embodiment, the event-labeled video stream 1304 stores directly into the storage device 208 that is coupled to the video processor (See FIG. 3).

The storage device 208 used by the video recording system 900 may include a FLASH memory. Although the primary limitation is that the write speed of the storage is sufficient for the frame rate that the video recording system 900 is operated. The amount of storage can vary, but 1 GB of storage can hold a bit less than 20 minutes of 1080P video at 60 FPS (frames per second). The FLASH memory modules may, for example, be UFS 3.0 FLASH memory or a similar type of FLASH memory that offers sufficient read/write performance. Furthermore, from the storage device of the video recording system 900, the event-labeled video stream 1304 can be saved on a USB, disc, UFS 3.0 FLASH memory, or other external storage device that offers sufficient read/write performance, as is known in the art.

Also, from the storage device, the event-labeled video stream 1304 can be directly accessed and viewed by the operator. The video stream may be viewable directly on the video recording system through a digital display 212, such as shown in FIG. 7. The display 212 can be, for example, a Liquid Crystal Display (LCD), an LED or an OLED display, or another type of display as long as the display is of sufficient resolution and refresh rate for the video camera operator to obtain a reasonable view of the scene that is being recorded. In certain implementations, the display 212 can be a touch-sensitive display, so that touch-sensitive input controls can be implemented as needed.

In a second possible video storage embodiment, the event-labeled video stream 1304 is manually transmitted to a remote data storage unit 1302 for storage thereon. In this storage configuration, the remote data storage unit 1302 is in communication with the storage device and/or the processor of the video recording system 900. In some embodiments, the remote data storage unit 1302 may include, without limitation, a cloud, a server, a database, a processor, a digital library, and a records storage site.

This remote transmission, storage, and organization to the remote data storage unit 1302 can be performed automatically, or through manual transmission of the video stream. For example, in automatic transmission, the event-labeled video stream 1304 is automatically transmitted and stored in the remote data storage unit 1302 without input from the operator. For example, integrated software in the storage device triggers the transmission of video streams to the remote data storage unit 1302 when the record control 156 is activated to begin recording video. Thus, when the record control is active, the video stream associated with the event 902 automatically transmits to the remote data storage unit 1302 for storage.

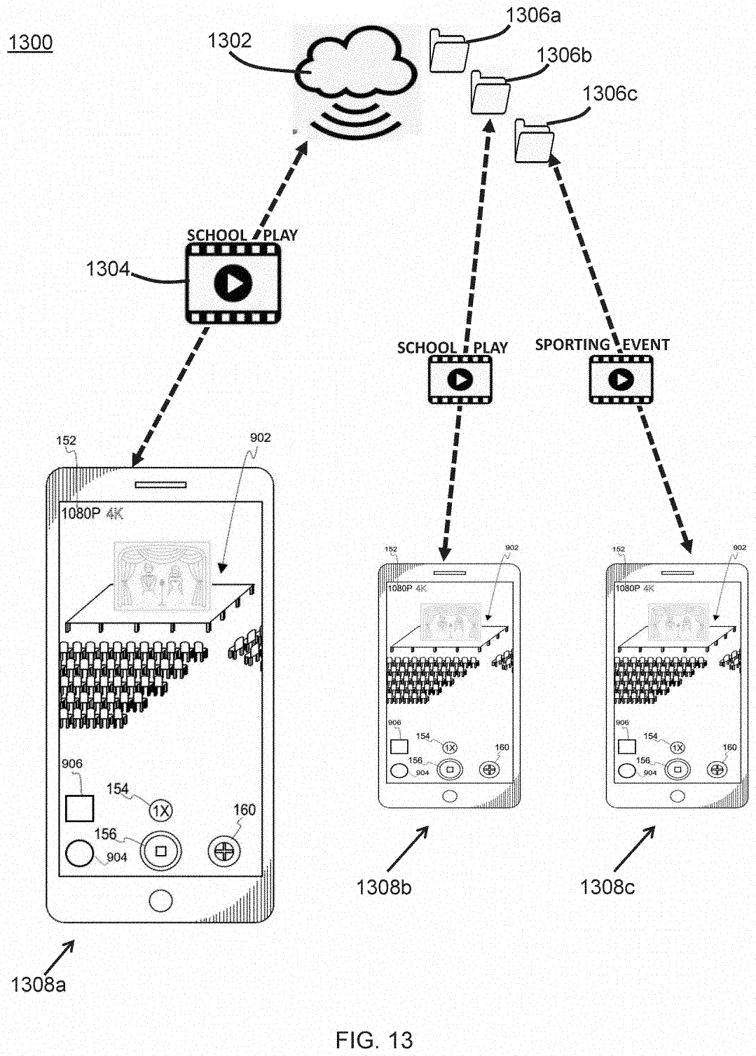

However, in other embodiments, it may be advantageous for the operator to manually initiate the transmission of event-labeled video stream 1304 to the remote data storage unit 1302. Thus, the video recording system 900 provides a remote storage control 906. The remote storage control 906 displays on the interface, adjacent of the event control 904 (See FIG. 13). The remote storage control 906 is configured for activation by the operator to manually initiate transmission of the video streams to the remote data storage unit 1302. Conversely, the operator can activate the remote storage control 906 to initiate transmission of the video streams from the remote data storage unit 1302 to the storage device in the video processor. In this arrangement, the event-labeled video stream 1304s transmit in both directions, per request of the operator.

The remote storage control 906 may include, without limitation, a hard button, a touch display on a smartphone, a voice control operable with voice recognition software, or another type of control. Thus, the video stream associated with the event 902 can be manually transmitted to the remote data storage unit 1302 through activation of the remote storage control 906.

As depicted in FIGS. 9 and 10, the remote storage control 906 is depicted with a logo of a cloud in the middle of a square control button when inactive, and an empty square when activated to transmit an event-labeled video stream 1304. It should be understood that many other representations of the remote storage control 906 and its active and inactive state can be utilized and still fall within the scope of the disclosed system and method.

Turning now to FIG. 13, the event-labeled video stream 1304 is not only stored, but segregated in the remote data storage unit 1302. This helps organize the video streams for easy identification and access. Thus, the remote data storage unit 1302 is adapted to both, store and segregate the logical master stream of video that is labeled with the event name 1104. For this purpose, the remote data storage unit 1302 comprises multiple folders 1306a-c.

In one possible embodiment, the folders 1306a, 1306b, 1306c are configured to segregate multiple master video streams of video labeled with the event name 1104. The folders 1306a-c can themselves be labeled with indicia to differentiate between the different event name 1104s applied to the video streams contained therein. The folders can also be labeled with the event name 1104. A date and time stamp may also be associated with the folders to indicate when the video stream was created.

As referenced in FIG. 13, the video recording systems 1308a, 1308b, 1308c communicate with the remote data storage unit 1302, and with each other, through a network 1300. In some embodiments, the network 1300 may include, without limitation, an Internet, an IEE 802.11 wireless network 1300, a 4G cellular network 1300, a 5G cellular network 1300, and a wired network 1300.

Consequently, the network 1300 allows multiple members to remain in communication in regards to the event-labeled video streams. In this manner, multiple video recording systems 1308a-c, including a ClippyCam, may simultaneously access the video streams associated with the event 902 from the remote data storage unit 1302.

Continuing with FIG. 13, the network 1300 includes multiple video recording systems 1308a-c that are operated by different members of the network 1300. Any network member can share an event name 1104, so that other members can access the corresponding video stream. The network members can also access the remote data storage unit 1302 to download and view the video streams associated with the event name 1104. The event name 1104, or other labeling, i.e., name, time stamp, location, helps network members identify and access the desired video streams.

In another possible embodiment, the network 1300 is controlled by a network administrator who regulates access to the video streams that are stored and transmitted to and from the data storage unit 1302. This regulation can include recording the event 902, applying an event name 1104 to the event 902, and making the different event names and labeled video streams accessible to select members of the network 1300. For example, the network administrator may require a password or credentials before granting access to an event name; and thereby viewing the event-labeled video stream 1304. In another example, the administrator allows a sporting event to be made accessible to network members who pay a fee to watch.

In yet other embodiments, the network 1300 utilizes a network interface 214. The network interface 214 allows the event control 904 and the input control to be activated by a network command. For example, the network interface 214 can interface directly with the video processor 206 and even the sensor 204, so that video can be directly streamed to the remote data storage unit 1302 via the network interface 214. In addition, certain other components, such as a microphone, may be present in the video recording system 900, but have been omitted for brevity and clarity.

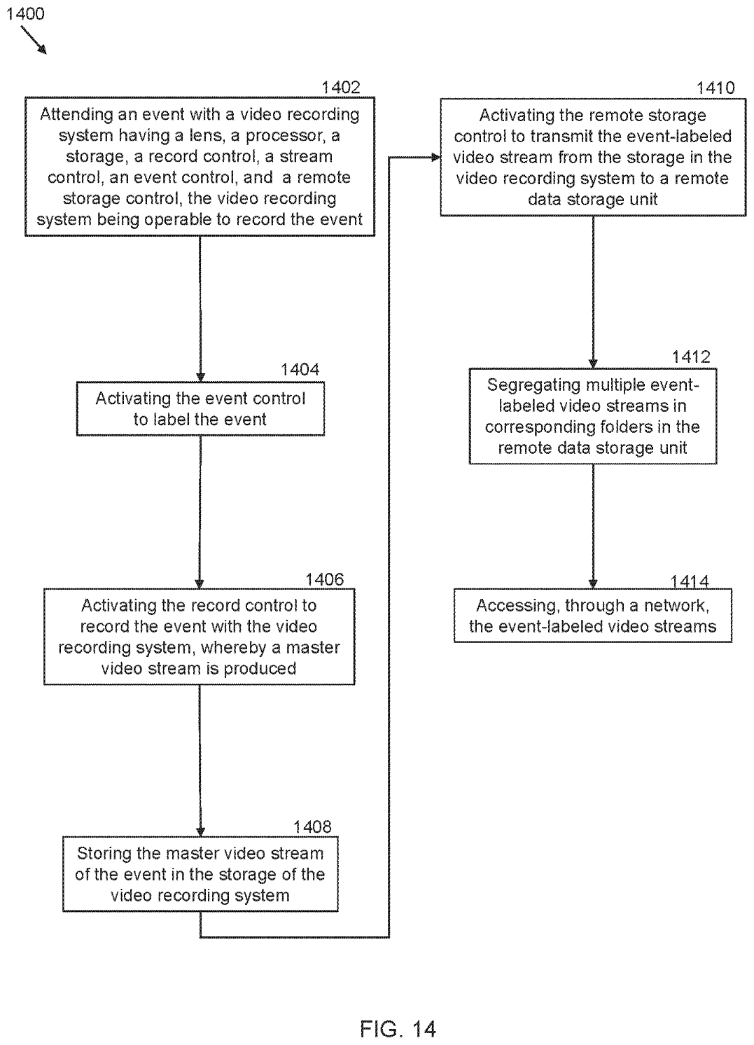

Turning to FIG. 14, a simplified flowchart depicts a method 1400 for associating a video recording to an event. The method 1400 may include an initial Step 1402 of attending an event with a video recording system having a lens, a processor, a storage, a record control, a stream control, an event control, and a remote storage control, the video recording system being operable to record the event. FIG. 3, a simplified block diagram of a video recording system 100 is depicted. In particular, the primary components of a video recording system 100 are depicted, whether the actual video recording system 100 is a smartphone, a digital camera, or a digital camcorder. Typically, the components of the video recording system 100 will reside in a body (not shown in this figure), although it is possible in certain implementations that different components can reside in separate enclosures, such as in the embodiment depicted in FIG. 7. At this point, the video recording system 900 is initiated; i.e., it is turned on; startup tasks are performed, etc.

The method may further comprise a Step 1404 of activating the event control to label the event. The event control 904 is activated by the operator to enable labeling of the event 902 with an event name 1104 to as user-defined specification. The event 902 is generally labeled prior to commencement of recording. This pre-recording labeling feature helps the operator in managing the labeling and organization of events while recording the video.

A Step 1406 includes activating the record control to record the event with the video recording system, whereby a master video stream is produced. The record control 156 allows the user to initiate the recording of video, or cause the recording of video to pause or stop. The record control 156 is shown as inactive (not recording) in FIG. 2a and active (recording) in FIG. 2b. In particular, as depicted, the record control has 156 a circle in the middle of the control when inactive, and a square in the middle of the control when active (recording).

In some embodiments, a Step 1408 may include storing the master video stream of the event in the storage of the video recording system. The video recording system 900 is also unique in that the event-labeled video stream 1304 is securely storable for organized identification and access by the operator, or members of a network 1300. In one embodiment, the event-labeled video stream 1304 stores directly into the storage device 208 that is coupled to the video processor (See FIG. 3).

A Step 1410 comprises activating the remote storage control to transmit the event-labeled video stream from the storage in the video recording system to a remote data storage unit. In another embodiment, the remote storage control 906 is activated to transmit the event-labeled video stream to the remote data storage unit 1302 for storage. At this point, the master video stream is terminated, which is usually accomplished by the user pressing the record control 156 again to cease recording, as depicted in, for example, FIGS. 2e and 2f.

The method 1400 may further comprise a Step 1412 of segregating multiple event-labeled video streams in corresponding folders in the remote data storage unit. The video recording system 900, an event 1200 comprises one or more subevents 1202a, 1202b. The subevents 1202a-b are simply spliced sections of the video stream for the event 1200. Thus, the recorded event 1200 can be organized into smaller sections of video streams. The events 1200 and subevents 1202a-b can be stored in folders 1306a-c and subfolders for organizing the video streams in a desired configuration.

A final Step 1414 includes accessing, through a network, the event-labeled video streams. The network 1300 allows multiple members to remain in communication in regards to the event-labeled video streams. In this manner, multiple video recording systems 1308a-c, including a ClippyCam, may simultaneously access the video streams associated with the event 902 from the remote data storage unit 1302. A network administrator may be used to regulate access and organization of the event-labeled video streams. Thereafter, the video recording system 900 is turned off, ending the operation of the system.

As discussed above, a ClippyCam is an effective video recording tool for operating the system 100. The ClippyCam recording instrument and software applications provides a user-friendly tool to record and edit videos that are labeled as events and subevents of the larger events. The ClippyCam feature also allows the recorded videos and video clips to be shared on a network. Thus, with the ClippyCam, an operator can easily record an event, and then edit and modify the video recording, such that the video clips or sections of the recording can be saved, viewed, and shared.

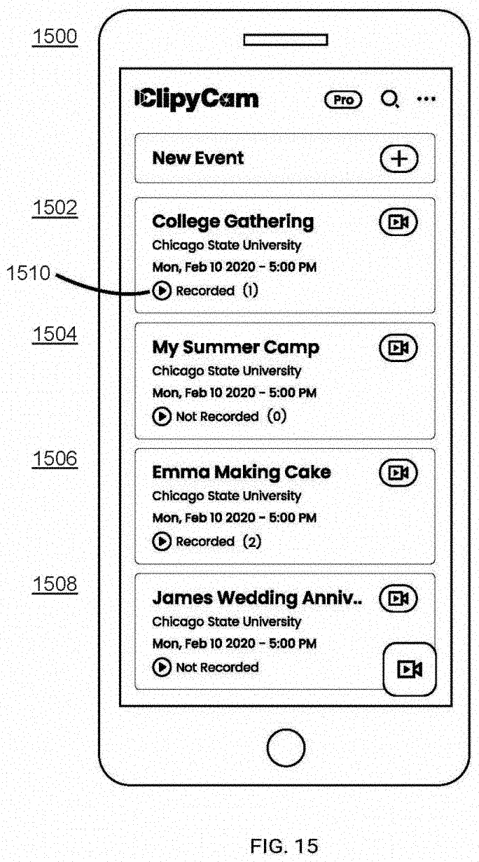

For example, FIG. 15 is a screenshot of ClippyCam enabled mobile communication device 1500 displaying multiple events. The events listed include: a College Gathering event 1502, a My Summer Camp event 1504, an Emma Making Cake event 1506, and a James Wedding Anniversary event 1508. Further, a recorded icon 1510 indicates if the event has been recorded yet, or simply labeled in preparation for recording. As shown, the College Gathering event 1502 has ben recorded, and is ready for viewing.

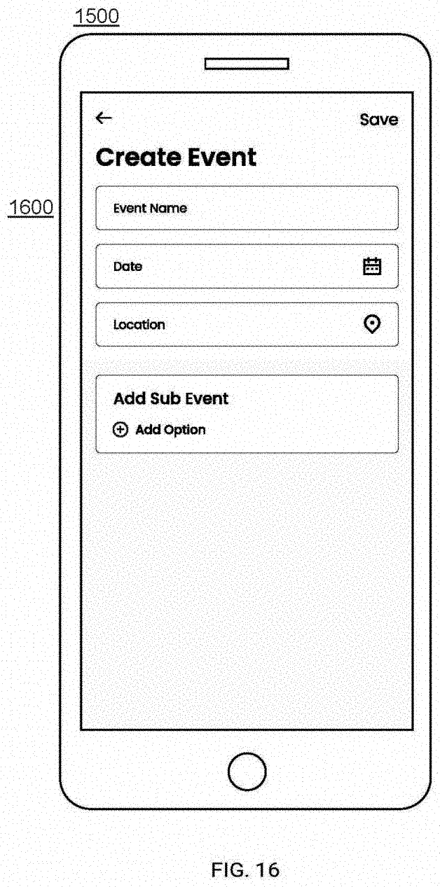

The aforementioned events have user-defined labels. So, as FIG. 16 illustrates, a screenshot of ClippyCam enabled mobile communication device 1500 provides an event text box 1600 to label the events. The user can simply type in the desired name for the event to be recorded. A keyboard automatically appears to enable the typing function. Though in some embodiments, a voice recognition function is also possible.

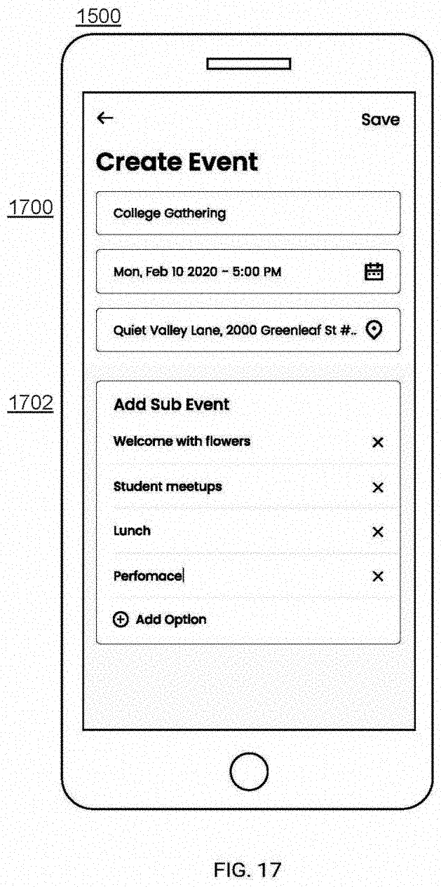

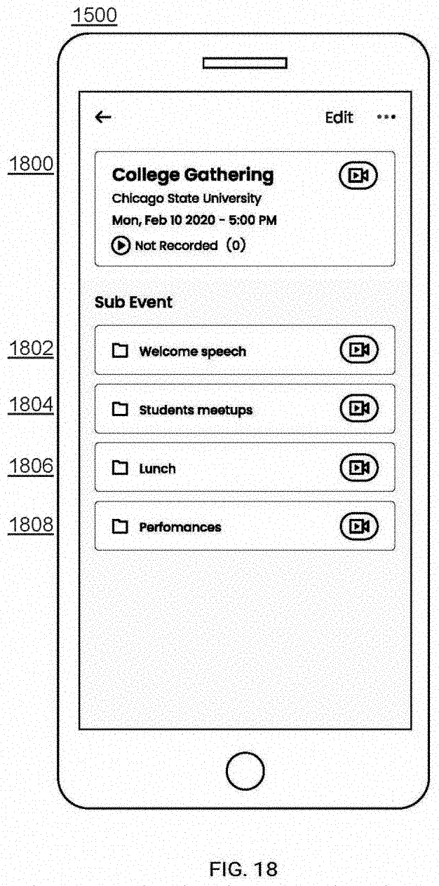

FIG. 17 is a screenshot of ClippyCam enabled mobile communication device 1500 with the event of a College Gathering 1700, the location of the event, and the date and time of the event, which are into the event text box. A subevent text box 1702 is also available to label the subevents, if any are used. FIG. 18 is a screenshot of ClippyCam enabled mobile communication device 1500 displaying the subevents of the College Gathering event. The event displays in detail, including location and time 1800. The subevents for the College Presentation event are labeled: Welcome Speech 1802; Student Meetups 1804; Luch 1806; and Performances 1808. Both the events and subevents are ready for viewing.

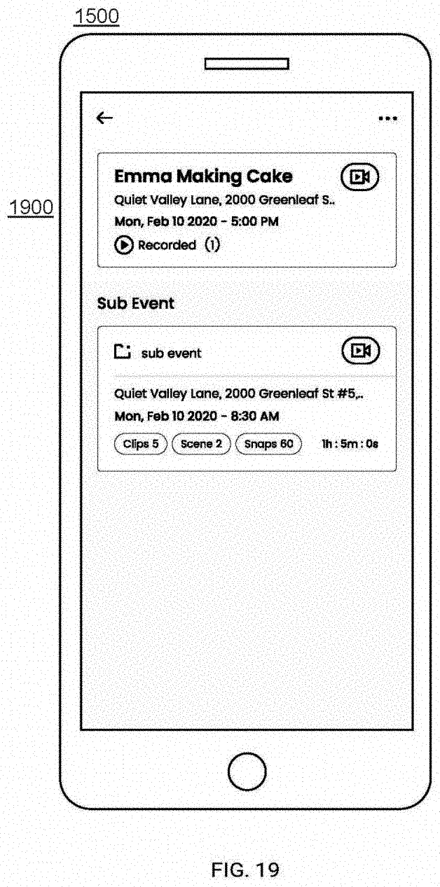

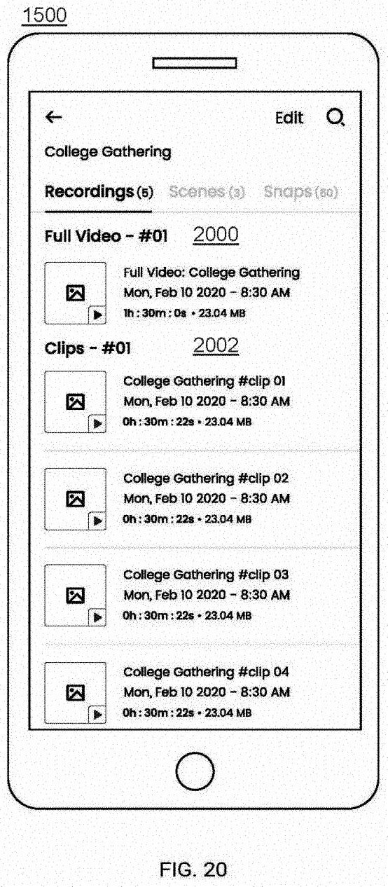

FIG. 19 is a screenshot of ClippyCam enabled mobile communication device 1500 with a fully entered subevent. The event 1900 is Emma Making Cake, and includes a subevent 1902 (video clip) with an address, date, and time for the video clip. In some embodiments, a thumbnail image of the full recordings are displayed. For example, FIG. 20 is a screenshot of ClippyCam enabled mobile communication device 1500 displaying video recordings of the College Gathering event, showing the entire video 200, and clips of the video 2002.

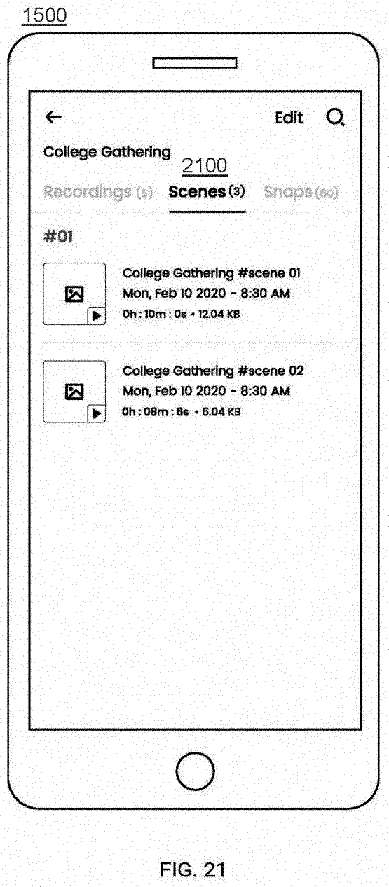

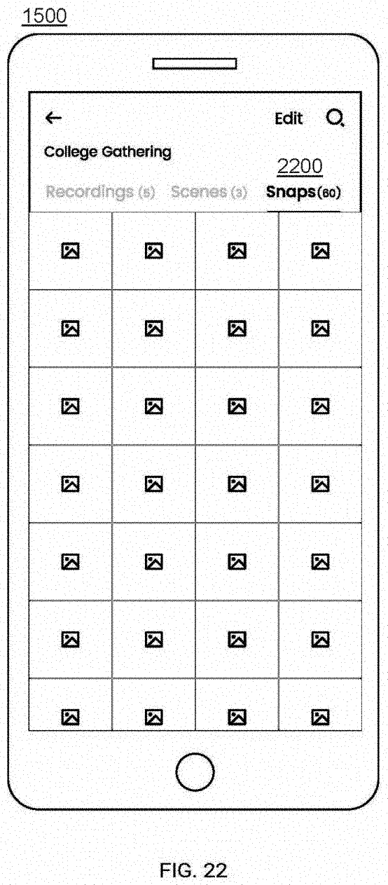

Continuing, with the event and subevent displays, FIG. 21 is a screenshot of ClippyCam enabled mobile communication device 1500 displaying scenes 2100 of the recording for the College Gathering event 1700. And finally, FIG. 22 is a screenshot of ClippyCam enabled mobile communication device 1500 displaying snapshot images 2200 of the scenes of the recording for the College Gathering event. The thumbnails allow for quick identification of a desired recording or video clip.

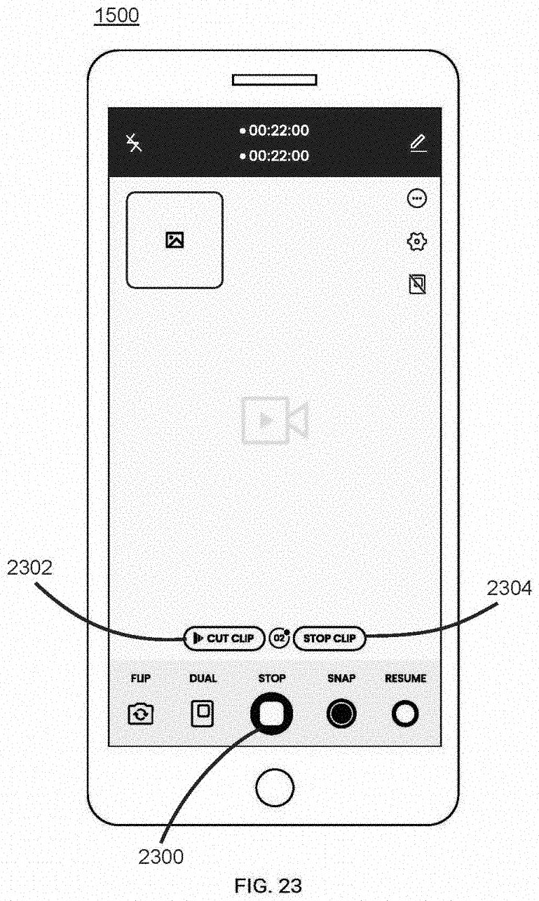

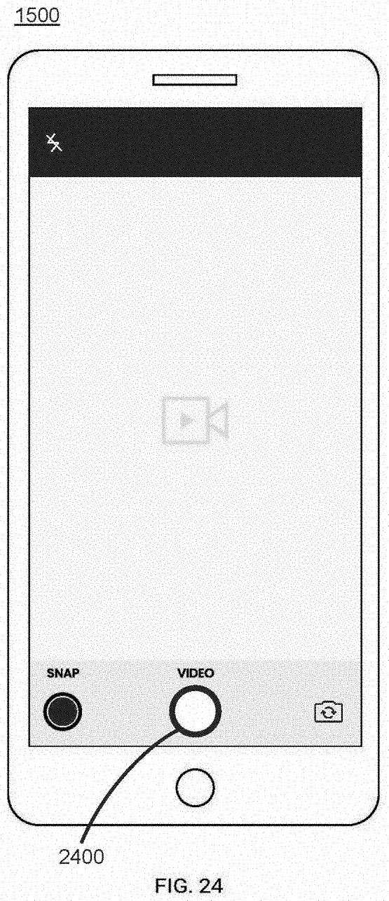

FIG. 23 is a screenshot of ClippyCam enabled mobile communication device 1500 displaying a Record button 2300 for recording the event, and also displaying a Cut Clip button 2302 that functions to delete an old clip, and start a new clip of the recording. A stop Clip 2304 button allows the recording of the video clip to cease. FIG. 24 is a screenshot of ClippyCam enabled mobile communication device 1500 displaying a Record button 2400 for recording the event, and offering the option to Stop Clip. It is significant to note that while Stop Clip button does stop the video clip, the master video stream continues to be recorded. Thus, in this configuration, the recording of the College Gathering event 1700 continues unimpeded.

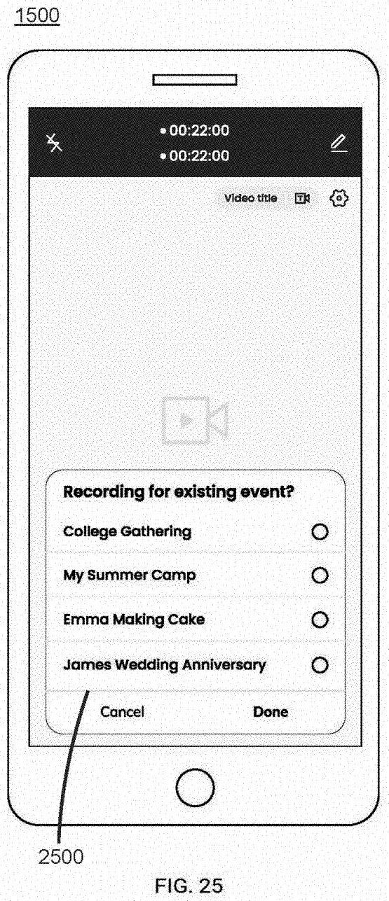

It is significant to note that the ClippyCam allows for recording from both the front and back side of the mobile communication device 1500. These dual recording views provide greater flexibility to the recording operator during production of the video. This also allows the recording operator to be seen in a selfie-styled video recording. For example, FIG. 23 shows the mobile communication device recording from the rear side, as the operator is shown. FIGS. 24-25 show the recording from the front side, as the College Gathering event 1700 is being recorded. In fact, a user can swap between the front camera and rear camera while a stream is being recorded merely by pressing an appropriate control.

Finally, FIG. 25 references a screenshot of a ClippyCam enabled mobile communication device 1500. As illustrated a pop-up selection box 2500 appears during the recording, requesting the operator to indicate whether the present recording is for a prior saved event. Specifically, the pop-up selection box 2500 inquires whether the recording is for an existing event, or a new event. If for an existing event, the video recording may be spliced to the event for further processing, labeling, etc. Thus, the ClippyCam feature works to help the operator edit and label the recordings.

As illustrated, the ClippyCam recording instrument and software applications provides a user-friendly tool to record and edit videos that are labeled as events and subevents of the larger events. The ClippyCam also allows the produced videos and video clips to easily be shared on a network. However, in other embodiments of the system, other types of cameras and video recording tools and apps may also be used, consistent with the described components and functions.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

The preceding description of the disclosure has been presented for purposes of illustration and description and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A video recording system comprising:
a sensor optically coupled to a lens, the sensor producing a stream of digital video data;
a video processor coupled to the sensor, the video processor processing the stream of digital video data and producing digital video frame data;
a storage device coupled to the video processor, the storage device storing the digital video frame data;
a processor coupled to the storage device, the processor maintaining a logical master stream of video generated from the digital video frame data stored in the storage device; and
an event control coupled to the processor that, on activation, is adapted to label the logical master stream of video with an event name,
whereby the event name labels the logical master stream that is associated with an event.

2. The video recording system of claim 1 wherein the event includes at least one of the following: a calendar event, a user-generated event, a social media event, and a holiday event.

3. The video recording system of claim 1 wherein the event comprises one or more subevents.

4. The video recording system of claim 1 wherein when the event control is activated, a keyboard appears to allow the event name to be entered in an event name box.

5. The video recording system of claim 1 further comprising a remote data storage unit adapted to store and segregate the logical master stream of video labeled with the event name.

6. The video recording system of claim 5 wherein the remote data storage unit comprises multiple folders adapted to segregate multiple master video streams of video labeled with the event name.

7. The video recording system of claim 5 wherein the remote data storage unit includes at least one of the following: a cloud, a server, a database, a processor, a digital library, and a records storage site.

8. The video recording system of claim 5 further comprising a remote storage control adapted to initiate transmission of the master video stream of video labeled with the event name to the remote data storage unit.

9. The video recording system of claim 8 wherein the event control and the remote storage control include at least one of the following: a hard button, a touch display on a digital display, and a voice control.

10. The video recording system of claim 5 wherein multiple video recording systems communicate with the remote data storage unit, and with each other, through a network.

11. The video recording system of claim 10 wherein the network includes at least one of the following: an Internet, an IEE 802.11 wireless network, a 4G cellular network, a 5G cellular network, and a wired network.

12. The video recording system of claim 1 further comprising a body, the body supporting the sensor and the lens.

13. The video recording system of claim 1 wherein the video recording system comprises a ClippyCam.

14. The video recording system of claim 1 wherein the logical master stream of video data comprises a start pointer and an end pointer, wherein the end pointer is continuously updated to point to the most recent digital data stored in the storage device.

15. The video recording system of claim 14 further comprising an input control coupled to the processor that, on activation, is adapted to create a second logical stream of video, the second logical stream of video comprising a second start pointer, wherein the second start pointer is adapted to be set to the value of the end pointer at the time that the second logical stream is created.

16. The video recording system of claim 15 wherein, on activation of the input control a second time, the second logical stream of video is adapted to be labeled with a name.

17. The video recording system of claim 16 wherein, the input control is adapted to create a third logical stream of video on activation a third time, the third logical stream of video comprising a third start pointer, the third start pointer is adapted to be set to the value of the end pointer at the time that the input control was activated a third time.

18. The video recording system of claim 15 further comprising a network interface and wherein the event control and the input control are adapted to be activated by a network command.

19. A video recording system comprising:
a body including a lens;
a video sensor optically coupled to the lens, the video sensor producing a stream of digital video data;
a video processor coupled to the video sensor, the video processor processing the stream of digital video data and producing digital video frame data;
a storage device coupled to the video processor, the storage device storing the digital video frame data;
a processor coupled to the storage device, the processor maintaining a logical master stream of video generated from the digital video frame data stored in the storage device, the logical master stream of video data comprising a start pointer and an end pointer, wherein the end pointer is continuously updated to point to the most recent digital data stored in the storage device;
an input control coupled to the processor that, on activation, is adapted to create a second logical stream of video, the second logical stream of video comprising a second start pointer, wherein the second start pointer is adapted to be set to the value of the end pointer at the time that the second logical stream is created,
whereby on activation of the input control a second time, the second logical stream of video is adapted to be labeled with a name,
whereby the input control is further adapted to create a third logical stream of video on activation a third time, the third logical stream of video comprising a third start pointer, the third start pointer is adapted to be set to the value of the end pointer at the time that the input control was activated a third time;
an event control coupled to the processor that, on activation, is adapted to label the logical master stream of video with an event name,
whereby when the event control is activated, a keyboard appears to allow the event name to be entered in an event name box,
whereby the event name labels the logical master stream that is associated with an event;
a remote data storage unit adapted to store and segregate the logical master stream of video labeled with the event name, the remote data storage unit comprising multiple folders adapted to segregate multiple master video streams of video labeled with the event name;
a remote storage control adapted to initiate transmission of the master video stream of video labeled with the event name to the remote data storage unit; and
a network interface and wherein the event control and the input control are adapted to be activated by a network command.

20. A video recording system comprising:
a video sensor producing a stream of digital video data;
a video processor coupled to the video sensor, the video processor processing the stream of digital video data and producing digital video frame data;
a storage device coupled to the video processor, the storage device storing the digital video frame data;
a processor coupled to the storage device, the processor maintaining a logical master stream of video, the logical master stream of video data comprising a start pointer and an end pointer, wherein the end pointer is continuously updated to point to the most recent digital data stored in the storage device; and
an input control coupled to the processor that, on activation, is adapted to create a second logical stream of video, the second logical stream of video comprising a second start pointer, wherein the second start pointer is adapted to be set to the value of the end pointer at the time that the second logical stream is created,
the second logical stream of video further comprising a second end pointer, and wherein, on activation of the input control a second time, the second end pointer is adapted to be set to the value of the end pointer at the time that the input control was activated the second time,
whereby on activation of the input control a second time, the second logical stream of video is adapted to be labeled with a name.
